(19) United States
(12) Patent Application Publication
(10) Pub. No.: US 2006/0233439 A1
(43) Pub. Date: Oct. 19, 2006

(54) Method and apparatus for processing a Bayer-pattern color digital image signal

(75) Inventor: Ming Zhao, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/349,046

(22) Filed: Feb. 7, 2006

(30) Foreign Application Priority Data
Feb. 7, 2005 (KR) 2005-0011443

(51) Int. Cl. G06K 9/00

(52) U.S. Cl. 382/168

(57) ABSTRACT

A method and apparatus for processing a Bayer-pattern color digital image signal are provided. The apparatus includes: a first defect detector generating first defect information of a first pixel to be processed from input image data; a second defect detector generating second defect information and horizontal and vertical gradients of the first pixel from the input image data; and a corrector compensating for a center-point defect, a thin line defect, or an edge defect in the first pixel according to the horizontal and vertical gradients using the first and second defect information to output corrected image data.

### CROSS-REFERENCE TO RELATED APPLICATION

This application claims priority to Korean Patent Application No. 10-2005-0011443, filed on Feb. 7, 2005, in the Korean Intellectual Property Office, the disclosure of which is incorporated by reference herein in its entirety.

### BACKGROUND OF THE INVENTION

1. Technical Field

The present invention relates to an apparatus for processing a digital image signal, and more particularly, to a method and apparatus for processing a Bayer-pattern color digital image signal generated by a solid state image sensing device.

2. Discussion of the Related Art

FIG. 1 is a block diagram of a, conventional solid state image sensing device 100. Referring to FIG. 1, the conventional solid state image sensing device 100 includes a complementary metal oxide semiconductor (CMOS) Image Sensor/Charge-Coupled Device (CIS/CCD) active pixel sensor (APS) array 110, a row driver 120, and an analog-to-digital converter (ADC) 130. The conventional solid state image sensing device 100 further includes a controller (not shown) for generating timing control signals for controlling the row driver 120 and the ADC 130 and addressing signals for selecting each pixel of the APS array 110 and outputting an image signal sensed by the APS array 110.

In a color solid state image sensing device, at least three types of color filters are disposed above each pixel of the APS array 110 to receive colored light as color signals. As shown in FIG. 2, a color filter array includes a Bayer-pattern in which a 2-color pattern of red (R) and green (G) colors is repeatedly disposed in a row and a 2-color pattern of G and blue (B) colors is repeatedly disposed in an adjacent row. Here, the G color, which is closely related to a luminance signal, is disposed in all rows and the R and B colors are alternately disposed in each row to improve a luminance resolution.

In the solid state image sensing device 100 having the APS array 110 with such a Bayer-pattern pixel structure, the APS array 110 senses light using a photodiode, converts the light into an electric signal, and generates an image signal. The image signal output from the APS array 110 is an analog image signal having R, G, and B colors. The ADC 130 then receives the analog image signal from the APS array 110 and converts the analog image signal into a digital image signal.

FIG. 3 is a block diagram of a conventional image signal processing system 300. Referring to FIG. 3, the conventional image signal processing system 300 includes a solid state image sensing device 310, an image signal processor 320, and a display device 330. The image signal processor 320 processes a digital image signal, having R, G, and B colors, output from the solid state image sensing device 310 and outputs the processed digital image signal to the display device 330 such as a liquid crystal display (LCD).

When an image is displayed using pixel data generated by the solid state image sensing device 310, the image may be distorted and the visual quality of the image may be deteriorated. However, by using the image signal processor 320, the pixel data generated by the solid state image sensing device 310 is interpolated and then output to the display device 330, thus improving the visual quality of the image.

However, since an output of a Bayer-pattern APS array used in an image signal processing system such as a mobile phone camera, a digital still camera, or the like may be subject to distortion such as aliasing, color moire, blurring, a false/pseudo color effect, and so forth, a need therefore exists for an apparatus and method capable of reducing distortion in an image signal processing system using a Bayer-pattern APS array.

### SUMMARY OF THE INVENTION

An apparatus for processing a Bayer-pattern color digital image signal to display a high quality image via a display device and a method of correcting a Bayer-pattern color digital image signal are provided.

According to an aspect of the present invention, there is provided a method of processing an image signal, including: generating first defect information of a first pixel to be processed from input image data; generating second defect information and horizontal and vertical gradients of the first pixel from the input image data; compensating for a center-point defect, a thin line defect, or an edge defect in the first pixel according to the horizontal and vertical gradients using the first and second defect information; and outputting corrected image data according to a result of the compensation.

The first defect information may be difference values indicating differences between the first pixel and pixels neighboring the first pixel, wherein the neighboring pixels have the same color as the first pixel. The horizontal gradient may be a sum of absolute values of differences among pixels neighboring the first pixel in a horizontal direction, wherein the neighboring pixels have the same color as the first pixel in a line along a row of the first pixel and lines above and under the row of the first pixel, the vertical gradient may be a sum of absolute values of differences among pixels neighboring the first pixel in a vertical direction, wherein the neighboring pixels have the same color as the first pixel in a line along a column of the first pixel and lines on the left and right sides of the column of the first pixel, and the second defect information may include differences between the first pixel and two pixels, wherein the two pixels have the same color as the first pixel in a direction of the smaller of the horizontal and vertical gradients.

Compensating for the center-point defect, the thin line defect, or the edge defect of the first pixel may include: classifying and outputting first, second, and third compensation class signals for the first pixel according to the horizontal and vertical gradients using the first and second defect information; compensating for the thin line defect in response to the first compensation class signal; compensating for the center-point defect in response to the second compensation class signal; and compensating for the edge defect in response to the third compensation class signal.

When the thin line defect is compensated, an image neighboring the first pixel may be in a complex area and is compensated, and when the center-point defect and the edge defect are compensated, the image neighboring the first pixel may be in a plain area and is compensated.

Classifying and outputting the first, second, and third compensation class signals for the first pixel may include: activating the first compensation class signal to compensate for the thin line defect if absolute values of the differences of the first defect information are larger than a first threshold value and the horizontal and vertical gradients are larger than a second threshold value; activating the second compensation class signal to compensate for the center-point defect if the absolute values of the differences of the first defect information are larger than the first threshold value and one of the horizontal and vertical gradients is smaller than the second threshold value; and activating the third compensation class signal to compensate for the edge defect if one of the absolute values of the differences of the first defect information is smaller than the first threshold value, one of the horizontal and vertical gradients is smaller than the second threshold value, and absolute values of the second defect information are larger than the first threshold value.

If one of the horizontal and vertical gradients is smaller than the second threshold value, the second defect information is generated.

The method may further include: determining that a white defect occurs when the differences of the first defect information are positive or determining that a black defect occurs when the differences of the first defect information are negative if absolute values of the differences of the first defect information are larger than the first threshold value; and determining that the white defect occurs when the differences of the second defect information are positive or determining that the black defect occurs when the differences of the second defect information are negative if one of the absolute values of the differences of the first defect information is smaller than the first threshold value, one of the horizontal and vertical gradients is smaller than the second threshold value, and absolute values of the second defect information are larger than the first threshold value.

The method may further include: compensating for the center-point defect and the edge defect by replacing data of the first pixel with a line mean in a direction of the smaller of the horizontal and vertical gradients for the white defect and by replacing the data of the first pixel with a minimum pixel value having the same color in the direction of the smaller of the horizontal and vertical gradients for the black defect; and compensating for the thin line defect by replacing data of the first pixel with a maximum value of four line means crossing the first pixel for the white defect and by replacing the data of the first pixel with a minimum value of the four line means for the black defect.

Each of the four line means is an average of two pixels having the same color as the first pixel crossed by one of horizontal, vertical and first and second diagonal lines, wherein the average does not include the first pixel. Eight pixels may neighbor the first pixel. The input image data may be a Bayer-pattern color digital image signal.

According to another aspect of the present invention, there is provided an apparatus for processing an image signal, including: a first defect detector generating first defect information of a first pixel to be processed from input image data; a second defect detector generating second defect information and horizontal and vertical gradients of the first pixel from the input image data; and a corrector compensating for a center-point defect, a thin line defect, or an edge defect in the first pixel according to the horizontal and vertical gradients using the first and second defect information to output corrected image data.

The first defect information may include difference values indicating differences between the first pixel and pixels neighboring the first pixel, wherein the neighboring pixels have the same color as the first pixel.

The horizontal gradient is a sum of absolute values of differences among pixels neighboring the first pixel in a horizontal direction, wherein the neighboring pixels have the same color as the first pixel in a line along a row of the first pixel and lines above and under the row of the first pixel, the vertical gradient is a sum of absolute values of differences among pixels neighboring the first pixel in a vertical direction, wherein the neighboring pixels have the same color as the first pixel in a line along a column of the first pixel and lines on the left and right sides of the column of the first pixel, and the second defect information comprises difference values indicating differences between the central pixel and two pixels, wherein the two pixels have the same colors as the first pixel in a direction of the smaller of the horizontal and vertical gradients.

The corrector comprises: a defect classifier generating first, second, and third compensation class signals for the first pixel according to the horizontal and vertical gradients using the first and second defect information; and a defect compensator compensating for the thin line defect in a complex area in response to the first compensation class signal, for the center-point defect in a plain area in response to the second compensation class signal, and for the edge defect in the plain area in response to the third compensation class signal.

The defect compensator comprises: a first compensator compensating for the thin line defect in the first pixel in response to the first compensation class signal; and a second compensator compensating for the center-point defect and the edge defect in the first pixel in response to the second and third compensation class signals.

The defect classifier activates the first compensation class signal to compensate for the thin line defect if absolute values of the differences of the first defect information are larger than a first threshold value and the horizontal and vertical gradients are larger than a second threshold value, activates the second compensation class signal to compensate for the center-point defect if the absolute values of the differences of the first defect information are larger than the first threshold value and one of the horizontal and vertical gradients is smaller than the second threshold value, and activates the third compensation class signal to compensate for the edge defect if one of the absolute values of the differences of the first defect information is smaller than the first threshold value, one of the horizontal and vertical gradients is smaller than the second threshold value, and absolute values of the second defect information are larger than the first threshold value.

If one of the horizontal and vertical gradients is smaller than the second threshold value, the second defect detector generates the second defect information.

The corrector also includes a multiplexer receiving an output of the first compensator and an output of the second compensator and selectively outputting the output of the first or second compensators as the corrected image data.

If absolute values of the differences of the first defect information are larger than the first threshold value, the defect compensator determines that a white defect occurs when the differences of the first defect information are positive or determines that a black defect occurs when the differences of the first defect information are negative, and if one of the absolute values of the differences of the first defect information is smaller than the first threshold value, one of the horizontal and vertical gradients is smaller than the second threshold value, and the absolute values of the second defect information are larger than the first threshold value, the defect compensator determines that the white defect occurs when the differences of the second defect information are positive or determines that the black defect occurs when the differences of the second defect information are negative.

The defect compensator compensates for the center-point defect and the edge defect by replacing data of the first pixel with a line mean in a direction of the smaller of the horizontal and vertical gradients for the white defect and by replacing the data of the first pixel with a minimum pixel value having the same color in the direction of the smaller of the horizontal and vertical gradients for the black defect, and compensates for the thin line defect by replacing the data of the first pixel with a maximum value of four line means crossing the first pixel for the white defect and a minimum value of the four line means for the black defect.

Each of the four line means is an average of two pixels having the same color as the first pixel crossed by one of horizontal, vertical and first and second diagonal lines, wherein the average does not include the first pixel. Eight pixels may neighbor the first pixel. The input image data may be a Bayer-pattern color digital image signal.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a conventional solid state image sensing device;

FIG. 2 illustrates a Bayer-pattern pixel array;

FIG. 3 is a block diagram of a conventional image signal processing system;

FIG. 4 is a block diagram of an image signal processing apparatus according to an exemplary embodiment of the present invention;

FIG. 5 is a block diagram of a corrector shown in FIG. 4;

FIG. 6 is a flowchart illustrating the operation of the image signal processing apparatus shown in FIG. 4:

FIG. 7 illustrates a difference between a central pixel G and a neighboring pixel;

FIG. 8 illustrates a difference between a central pixel R and a neighboring pixel;

FIG. 9 illustrates a horizontal gradient of pixel data; and

FIG. 10 illustrates a vertical gradient of pixel data.

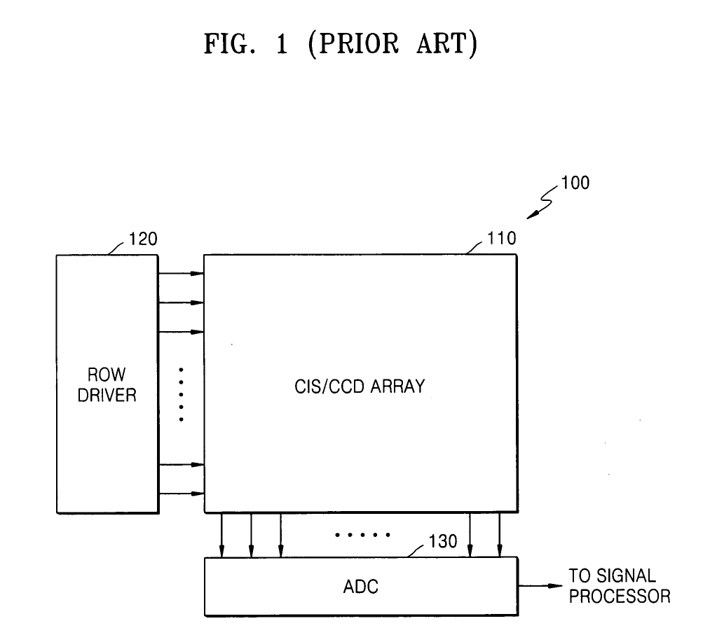

### DETAILED DESCRIPTION OF EXEMPLARY EMBODIMENTS

Hereinafter, exemplary embodiments of the present invention will be described in detail with reference to the attached drawings. Like reference numerals in the drawings denote like elements.

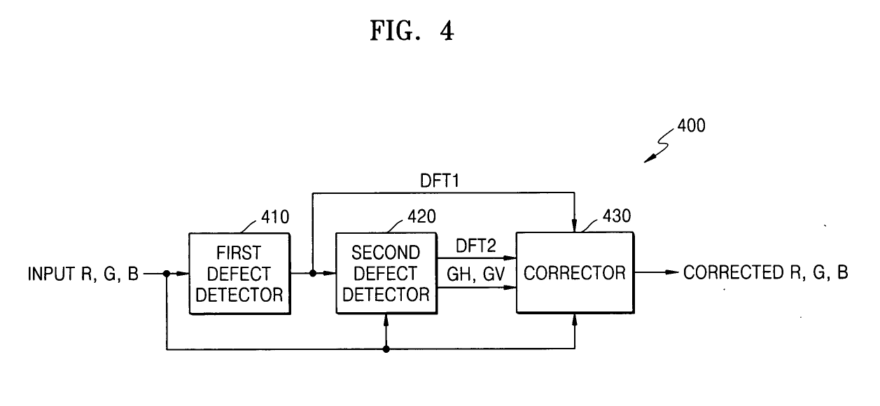

FIG. 4 is a block diagram of an image signal processing apparatus 400 according to an embodiment of the present invention. Referring to FIG. 4, the image signal processing apparatus 400 includes a first defect detector 410, a second defect detector 420, and a corrector 430.

The image signal processing apparatus 400 may be used in an image signal processing system such as a mobile phone camera, a digital still camera, or the like. The image signal processing apparatus 400 may process digital image data (e.g., R, G, and B color signals) output from a solid state image sensing device using a CIS/CCD array and compensate for signal distortion of the digital image data to display a high quality image.

As shown in FIG. 4, the first defect detector 410 generates first defect information DFT1 of a central pixel to be processed from the input digital image data. The input digital image data may be Bayer-pattern R, G, and B digital data output from the solid state image sensing device.

The second defect detector 420 generates second defect information DFT2, a horizontal gradient GH, and a vertical gradient GV of the central pixel from the input digital image data.

The corrector 430 compensates for a center-point defect, a thin line defect, and an edge defect of the central pixel according to the horizontal and vertical gradients GH and GV using the first and second defect information DFT1 and DFT2 to output corrected image data (e.g., corrected R, G, and B color signals).

It is to be understood by one of ordinary skill in the art that the center-point defect refers to a defect occurring in a center-point of, for example, a central pixel of a plain area of an image. The thin line defect refers to a defect occurring in a thin line of a complex area of the image and the edge defect refers to a defect occurring in a sharp line of the plain area of the image. It is to be further understood by one of ordinary skill in the art that the complex area refers to an area of the image in which a color varies substantially, and the plain area refers to an area of the image in which a color does not vary substantially.

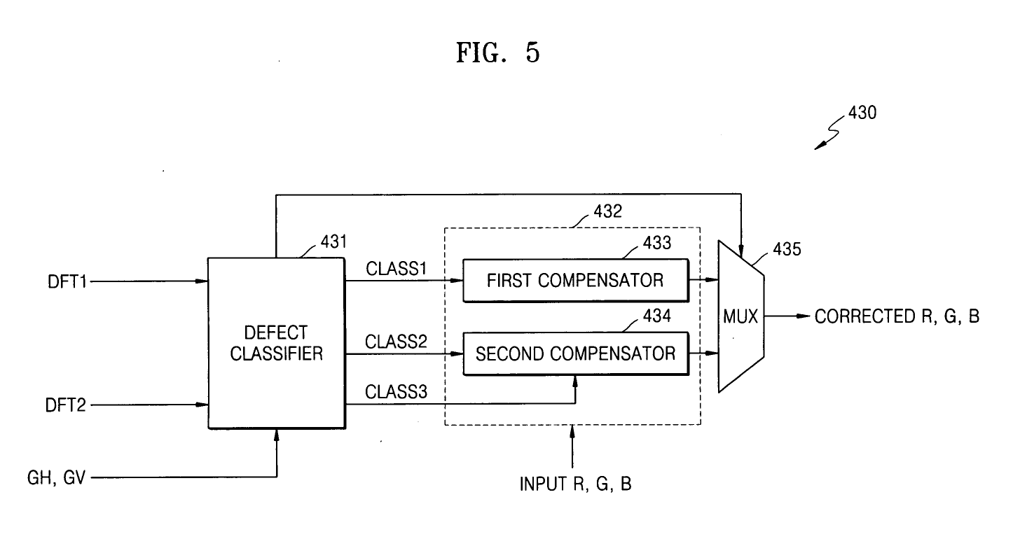

FIG. 5 is a block diagram of the corrector 430 shown in FIG. 4. Referring to FIG. 5, the corrector 430 includes a defect classifier 431, a defect compensator 432, and a multiplexer 435.

The defect classifier 431 generates first, second, and third compensation class signals CLASS1, CLASS2, and CLASS3 for the central pixel according to the horizontal and vertical gradients GH and GV by using the first and second defect information DFT1 and DFT2.

The defect compensator 432 includes first and second compensators 433 and 434. The first compensator 433 compensates for the thin line defect in the central pixel in response to the first compensation class signal CLASS1 to output corrected image data to the multiplexer 435. The second compensator 434 compensates for the center-point defect and the edge defect in the central pixel in response to the second and third compensation class signals CLASS2 and CLASS3 to output corrected image data to the multiplexer 435.

When compensating for the thin line defect in the first compensator 433, the neighborhood of the central pixel to be processed is determined as the complex area of the image and the input digital image data is processed to be suitable for the complex area to reduce a distortion of the input digital image data. When compensating for the center-point defect and the edge defect in the second corrector 434, the neighborhood of the central pixel is determined as the plain area of the image and the input digital image data is processed to be suitable for the plain area to reduce a distortion of the input digital image data.

As will be described in more detail below with reference to FIGS. 4-10, the center-point defect and the edge defect are substantially corrected by the second corrector 434 using the same method.

As shown in FIG. 5, the multiplexer 435 is controlled by the defect classifier 431 to selectively output an output of the first or second compensators 433 or 434. For example, when the first compensation class signal CLASS1 is activated, the multiplexer 435 selects the output of the first compensator 433 and when the second or third compensation class signal CLASS2 or CLASS3 is activated, the multiplexer 435 selects the output of the second compensator 434.

The operation of the image signal processing apparatus 400 will now be described in more detail with reference to FIGS. 4-10.

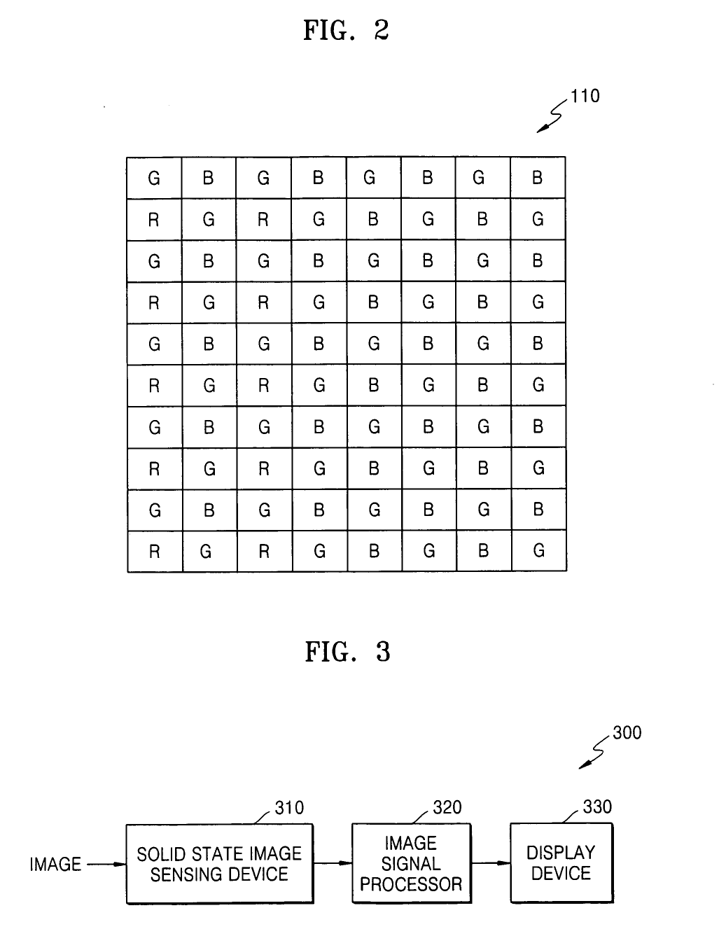

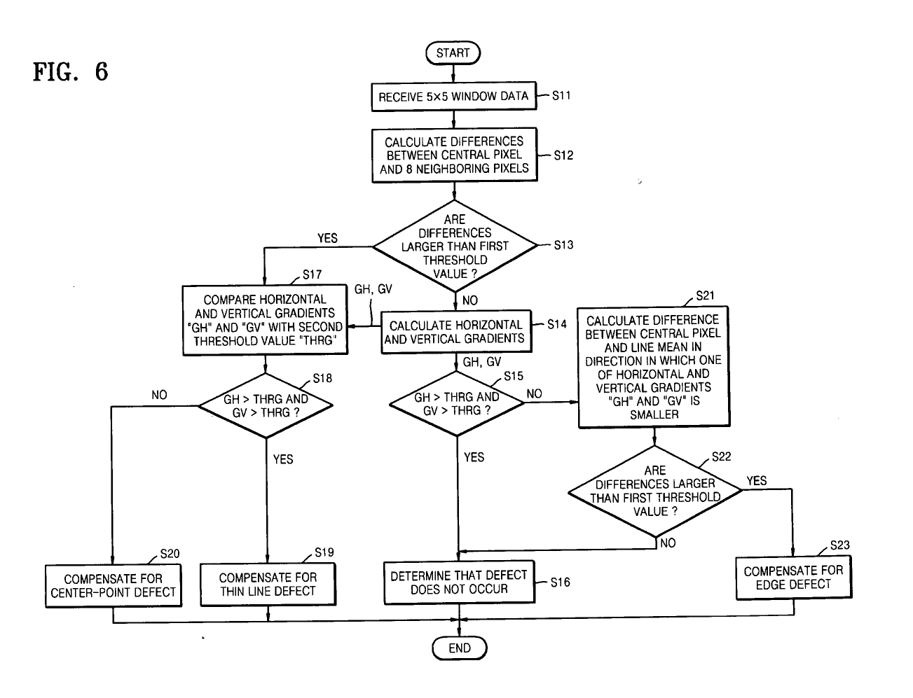

FIG. 6 is a flowchart illustrating the operation of the image signal processing apparatus 400. Referring to FIG. 6, in operation S11, the image signal processing apparatus 400 receives 5×5 window data. The 5×5 window data is Bayer-pattern digital data as shown, for example, in FIG. 2, and the image signal processing apparatus 400 moves a central pixel to be processed by at least one pixel to generate corrected image data for each central pixel R, G, or B of the 5×5 window data.

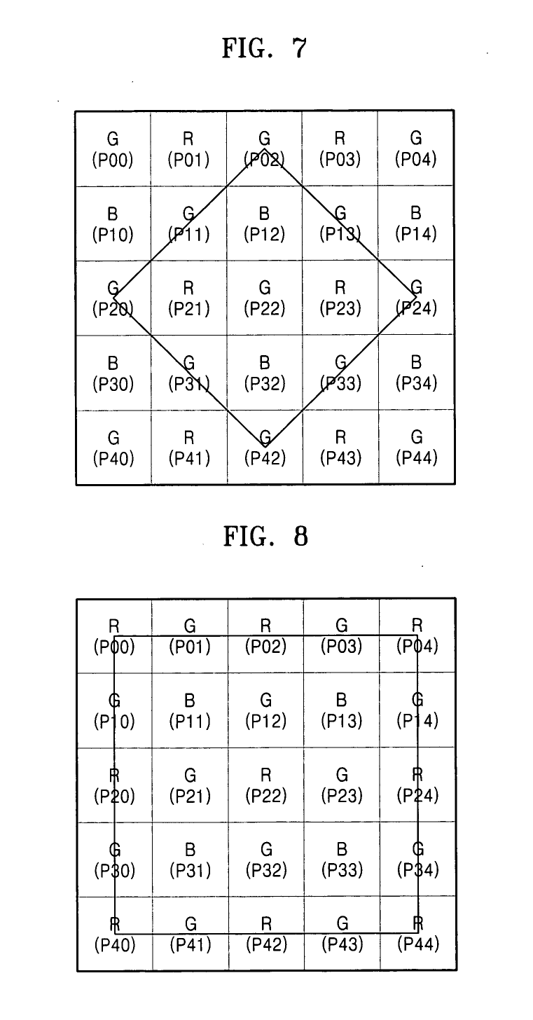

Examples of 5×5 window data neighboring a central pixel are shown in FIGS. 7 and 8. For example, FIG. 7 illustrates 5×5 window data neighboring a central pixel G to be processed, and FIG. 8 illustrates 5×5 window data neighboring a central pixel R to be processed. 5×5 window data neighboring a central pixel B (not shown) to be processed is received according to the same method as the central pixels and R and G.

Referring back to FIG. 6, in operation S12, the first defect detector 410 generates the first defect information DFT1 of the central pixel to be processed from the 5×5 window data. The first defect information DFT1 includes difference values indicating differences between the central pixel and 8 neighboring pixels having the same color as the central pixel. For example, as shown in FIG. 7, the first defect information DFT1 of the central pixel G is “P22-P02,” “P22-P13,” “P22-P24,” “P22-P33,” “P22-P42,” “P22-P31,” “P22-P20,” and “P22-P11.” As shown in FIG. 8, the first defect information DFT1 of the central pixel R is “P22-P02,” “P22-P04,” “P22-P24,” “P22-P44,” “P22-P42,” “P22-P40,” “P22-P20,” and “P22-P00.” The first defect information DFT1 of the central pixel B (not shown) is calculated using the same method as the central pixel R.

In operation S13, a determination is made as to whether absolute values of the differences of the first defect information DFT1 are larger than a first threshold value THR. If it is determined that the absolute values of the differences of the first defect information DFT1 are larger than the first threshold value THR, in operation S20, the center-point defect is compensated or in operation S19, the thin line defect is compensated. If it is determined that some of the absolute values of the differences of the first defect information DFT1 are not larger than the first threshold value THR, in operation S16, it is determined that a defect does not occur or in operation S23, the edge defect is compensated. The determinations are performed by the corrector 430.

In operation S14, the second defect detector 420 generates the horizontal and vertical gradients GH and GV of the central pixel from the 5×5 window data.

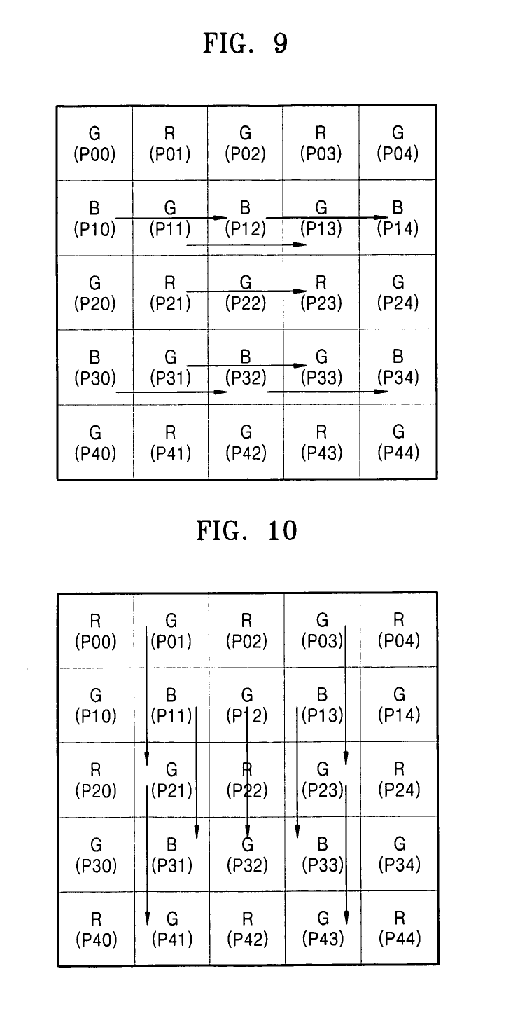

FIG. 9 illustrates the horizontal gradient GH. As shown in FIG. 9, the horizontal gradient GH is a sum of absolute values of differences among pixels neighboring the central pixel G in a horizontal direction having the same color as the central pixel G in a line along a row of the central pixel G and lines under and above the row of the central pixel G. Referring to FIG. 9, the horizontal gradient GH can be expressed as shown in Equation 1:
GH=|P10-P12|+|P12-P14|+|P11-P13|+|P21-P23|+|P30-P32|+|P32-P34|+|P31-P33| (1)

FIG. 10 illustrates the vertical gradient GV. As shown in FIG. 10, the vertical gradient GV is a sum of absolute values of differences among pixels neighboring the central pixel R in a vertical direction having the same color as the central pixel R in a line along a column of the central pixel R and lines on the left and right sides of the column of the central pixel R. Referring to FIG. 10, the vertical gradient GV can be expressed as shown in Equation 2:
GV=|P01-P21|+|P21-P41|+|P11-P31|+|P12-P32|+|P03-P23|+|P23-P43|+|P13-P33| (2)

Referring back to FIG. 6, in operation S15, the second defect detector 420 compares the horizontal and vertical gradients GH and GV with a second threshold value THRG. If at least one of the horizontal and vertical gradients GH and GV is smaller than the second threshold value THRG, in operation S21, the second defect information DFT2 is generated. The second defect information DFT2 includes two difference values indicating the difference between the central pixel and two pixels having the same color as the central pixel and located in a direction of the smaller of the horizontal and vertical gradients. If the horizontal and vertical gradients GH and GV are larger than the second threshold value THRG, in operation S16, it is determined that a defect does not occur.

Thus, if the absolute values of the differences of the first defect information DFT1 are larger than the first threshold value THR, in operation S17, the defect classifier 431 of the corrector 430 compares the horizontal and vertical gradients GH and GV with the second threshold value THRG. In operation S18, the defect classifier 431 determines whether the horizontal and vertical gradients GH and GV are larger than the second threshold value THRG.

If the defect classifier 431 determines in operation S18 that the horizontal and vertical gradients GH and GV are larger than the second threshold value THRG, in operation S19, the defect classifier 431 activates the first compensation class signal CLASS1 to compensate for the thin line defect. If at least one of the horizontal and vertical gradients GH and GV is smaller than the second threshold value THRG, in operation S20, the defect classifier 431 activates the second compensation class signal CLASS2 to compensate for the center-point defect.

If at least one of the absolute values of the differences of the first defect information DFT1 generated in operation S12 is smaller than the first threshold value THR, and at least one of the horizontal and vertical gradients GH and GV is smaller than the second threshold value THRG, in operation S22, the defect classifier 431 compares two absolute values of the differences of the second defect information DFT2 generated in operation S21 with the first threshold value THR.

If at least one of the two absolute values of the second defect information DFT2 is smaller than the first threshold value THR, in operation S16, it is determined that the defect does not occur. If the two absolute values of the second defect information DFT2 are larger than the first threshold value THR, the defect classifier 431 activates the third compensation class signal CLASS3 to compensate for the edge defect.

The first compensator 433 of the corrector 430 compensates for the thin line defect in the central pixel in response to the first compensation class signal CLASS1 to output corrected image data. The second compensator 434 of the corrector 430 compensates for the center-point defect and the edge defect in the central pixel in response to the second and third compensation class signals CLASS2 and CLASS3 to output corrected image data.

To compensate for the thin line defect and the edge defect, if the absolute values of the differences of the first defect information DFT1 generated in operation S12 are larger than the first threshold value THR, the first and second compensators 433 and 434 determine that a white defect occurs when the difference values of the first defect information DFT1 are positive or determine that a black defect occurs when the difference values of the first defect information DFT1 are negative.

To compensate for the edge defect, if at least one the absolute values of the differences of the first defect information DFT1 is smaller than the first threshold value THR, and at least one of the horizontal and vertical gradients GH and GV is smaller than the second threshold value THRG, and the two absolute values of the second defect information DFT2 are larger than the first threshold value THR, the first and second compensators 433 and 434 determine that the white defect occurs when the two difference values of the second defect information DFT2 are positive or determine that the black defect occurs when the two difference values of the second defect information DFT2 are negative.

To compensate for the thin line defect in the complex area neighboring the central pixel, for the white defect, the first compensator 433 replaces a maximum value of four line means crossing the central pixel as the data of the central pixel. For the black defect, the first compensator 433 replaces a minimum value of the four line means as the data of the central pixel.

Each of the four line means is an average of at least two pixels having the same color as the central pixel. The average does not include the central pixel R, G, or B crossed by each of the horizontal, vertical, and first and second diagonal lines. For example, referring to FIG. 9, a horizontal line mean of the central pixel G is an average of P20 and P24. A vertical line mean of the central pixel G is an average of P02 and P42.

Still referring to FIG. 9, the first diagonal line mean of the central pixel G is an average of P11 and P33 as shown in FIG. 9, and the first diagonal line mean of the central pixel R and/or B is an average of P00 and P44 as shown in FIG. 10. The second diagonal line mean of the central pixel G is an average of P13 and P31 as shown in FIG. 9, and the second diagonal line mean of the central pixel R and/or B is an average of P04 and P40 as shown in FIG. 10.

To compensate for the center-point defect and the edge defect in the plain area neighboring the central pixel, for the white defect, the second compensator 434 replaces the data of the central pixel with a line mean in a (horizontal or vertical) direction in which one of the horizontal and vertical gradients GH and GV is smaller. For the black defect, the second compensator 434 replaces the data of the central pixel with a minimum pixel value having the same color as the central pixel in the (horizontal or vertical) direction.

As described above, in the image signal processing apparatus 400 according to an exemplary embodiment of the present invention, the first defect detector 410 generates the first defect information DFT1 of the central pixel to be processed from the input digital image data, and the second defect detector 420 generates the second defect information DFT2 and the horizontal and vertical gradients GH and GV of the central pixel from the input digital image data. The corrector 430 then compensates for the center-point defect, the thin line defect, and the edge defect in the central pixel according to the horizontal and vertical gradients GH and GV using the first and second defect information DFT1 and DFT2.

As described above, an apparatus for processing a Bayer-pattern color digital image signal according to an exemplary embodiment of the present invention can be applied to a system such as a digital still camera, a mobile phone camera, or the like to detect a defect of the Bayer-pattern color digital image signal and compensate for the Bayer-pattern color digital image signal. As a result, aliasing, color moire, blurring, a false/pseudo color effect, or the like can be minimized to improve visual quality of an image signal processing system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing an image signal, comprising:
generating first defect information of a first pixel to be processed from input image data;
generating second defect information and horizontal and vertical gradients of the first pixel from the input image data;
compensating for a center-point defect, a thin line defect, or an edge defect in the first pixel according to the horizontal and vertical gradients using the first and second defect information; and
outputting corrected image data according to a result of the compensation.

2. The method of claim 1, wherein the first defect information comprises difference values indicating differences between the first pixel and pixels neighboring the first pixel, wherein the neighboring pixels have the same color as the first pixel.

3. The method of claim 2, wherein:
the horizontal gradient is a sum of absolute values of differences among pixels neighboring the first pixel in a horizontal direction, wherein the neighboring pixels have the same color as the first pixel in a line along a row of the first pixel and lines above and under the row of the first pixel,
the vertical gradient is a sum of absolute values of differences among pixels neighboring the first pixel in a vertical direction, wherein the neighboring pixels have the same color as the first pixel in a line along a column of the first pixel and lines on the left and right sides of the column of the first pixel, and
the second defect information comprises differences between the first pixel and two pixels, wherein the two pixels have the same color as the first pixel in a direction of the smaller of the horizontal and vertical gradients.

4. The method of claim 3, wherein compensating for the center-point defect, the thin line defect, or the edge defect of the first pixel comprises:
classifying and outputting first, second, and third compensation class signals for the first pixel according to the horizontal and vertical gradients using the first and second defect information;
compensating for the thin line defect in response to the first compensation class signal;
compensating for the center-point defect in response to the second compensation class signal; and
compensating for the edge defect in response to the third compensation class signal.

5. The method of claim 4, wherein when the thin line defect is compensated, an image neighboring the first pixel is in a complex area and is compensated, and when the center-point defect and the edge defect are compensated, the image neighboring the first pixel is in a plain area and is compensated.

6. The method of claim 4, wherein classifying and outputting the first, second, and third compensation class signals for the first pixel comprises:
activating the first compensation class signal to compensate for the thin line defect if absolute values of the differences of the first defect information are larger than a first threshold value and the horizontal and vertical gradients are larger than a second threshold value;
activating the second compensation class signal to compensate for the center-point defect if the absolute values of the differences of the first defect information are larger than the first threshold value and one of the horizontal and vertical gradients is smaller than the second threshold value; and
activating the third compensation class signal to compensate for the edge defect if one of the absolute values of the differences of the first defect information is smaller than the first threshold value, one of the horizontal and vertical gradients is smaller than the second threshold value, and absolute values of the second defect information are larger than the first threshold value.

7. The method of claim 6, wherein if one of the horizontal and vertical gradients is smaller than the second threshold value, the second defect information is generated.

8. The method of claim 4, further comprising:
determining that a white defect occurs when the differences of the first defect information are positive or determining that a black defect occurs when the differences of the first defect information are negative, if absolute values of the differences of the first defect information are larger than the first threshold value; and
determining that the white defect occurs when the differences of the second defect information are positive or determining that the black defect occurs when the differences of the second defect information are negative, if one of the absolute values of the differences of the first defect information is smaller than the first threshold value, one of the horizontal and vertical gradients is smaller than the second threshold value, and absolute values of the second defect information are larger than the first threshold value.

9. The method of claim 8, further comprising:
compensating for the center-point defect and the edge defect by replacing data of the first pixel with a line mean in a direction of the smaller of the horizontal and vertical gradients for the white defect and by replacing the data of the first pixel with a minimum pixel value having the same color in the direction of the smaller of the horizontal and vertical gradients for the black defect; and
compensating for the thin line defect by replacing the data of the first pixel with a maximum value of four line means crossing the first pixel for the white defect and a minimum value of the four line means for the black defect.

10. The method of claim 9, wherein each of the four line means is an average of two pixels having the same color as the first pixel crossed by one of horizontal, vertical and first and second diagonal lines, wherein the average does not include the first pixel.

11. The method of claim 2, wherein 8 pixels neighbor the first pixel.

12. The method of claim 1, wherein the input image data is a Bayer-pattern color digital image signal.

13. An apparatus for processing an image signal, comprising:
a first defect detector generating first defect information of a first pixel to be processed from input image data;
a second defect detector generating second defect information and horizontal and vertical gradients of the first pixel from the input image data; and
a corrector compensating for a center-point defect, a thin line defect, or an edge defect in the first pixel according to the horizontal and vertical gradients using the first and second defect information to output corrected image data.

14. The apparatus of claim 13, wherein the first defect information comprises difference values indicating differences between the first pixel and pixels neighboring the first pixel, wherein the neighboring pixels have the same color as the first pixel.

15. The apparatus of claim 14, wherein:
the horizontal gradient is a sum of absolute values of differences among pixels neighboring the first pixel in a horizontal direction, wherein the neighboring pixels have the same color as the first pixel in a line along a row of the first pixel and lines above and under the row of the first pixel,
the vertical gradient is a sum of absolute values of differences among pixels neighboring the first pixel in a vertical direction, wherein the neighboring pixels have the same color as the first pixel in a line along a column of the first pixel and lines on the left and right sides of the column of the first pixel, and
the second defect information comprises difference values indicating differences between the central pixel and two pixels, wherein the two pixels have the same colors as the first pixel in a direction of the smaller of the horizontal and vertical gradients.

16. The apparatus of claim 15, wherein the corrector comprises:
a defect classifier generating first, second, and third compensation class signals for the first pixel according to the horizontal and vertical gradients using the first and second defect information; and
a defect compensator compensating for the thin line defect in a complex area in response to the first compensation class signal, for the center-point defect in a plain area in response to the second compensation class signal, and for the edge defect in the plain area in response to the third compensation class signal.

17. The apparatus of claim 16, wherein the defect compensator comprises:
a first compensator compensating for the thin line defect in the first pixel in response to the first compensation class signal; and
a second compensator compensating for the center-point defect and the edge defect in the first pixel in response to the second and third compensation class signals.

18. The apparatus of claim 17, wherein the defect classifier activates the first compensation class signal to compensate for the thin line defect if absolute values of the differences of the first defect information are larger than a first threshold value and the horizontal and vertical gradients are larger than a second threshold value, activates the second compensation class signal to compensate for the center-point defect if the absolute values of the differences of the first defect information are larger than the first threshold value and one of the horizontal and vertical gradients is smaller than the second threshold value, and activates the third compensation class signal to compensate for the edge defect if one of the absolute values of the differences of the first defect information is smaller than the first threshold value, one of the horizontal and vertical gradients is smaller than the second threshold value, and absolute values of the second defect information are larger than the first threshold value.

19. The apparatus of claim 18, wherein if one of the horizontal and vertical gradients is smaller than the second threshold value, the second defect detector generates the second defect information.

20. The apparatus of claim 17, wherein the corrector further comprises:
a multiplexer receiving an output of the first compensator and an output of the second compensator and selectively outputting the output of the first or second compensators as the corrected image data.

21. The apparatus of claim 16, wherein if absolute values of the differences of the first defect information are larger than the first threshold value, the defect compensator determines that a white defect occurs when the differences of the first defect information are positive or determines that a black defect occurs when the differences of the first defect information are negative, and
if one of the absolute values of the differences of the first defect information is smaller than the first threshold value, one of the horizontal and vertical gradients is smaller than the second threshold value, and the absolute values of the second defect information are larger than the first threshold value, the defect compensator determines that the white defect occurs when the two differences of the second defect information are positive or determines that the black defect occurs when the two differences of the second defect information are negative.

22. The apparatus of claim 21, wherein the defect compensator compensates for the center-point defect and the edge defect by replacing data of the first pixel with a line mean in a direction of the smaller of the horizontal and vertical gradients for the white defect and by replacing the data of the first pixel with a minimum pixel value having the same color in the direction of the smaller of the horizontal and vertical gradients for the black defect, and compensates for the thin line defect by replacing data of the first pixel with a maximum value of four line means crossing the first pixel for the white defect and a minimum value of the four line means for the black defect.

23. The apparatus of claim 22, wherein each of the four line means is an average of two pixels having the same color as the first pixel crossed by one of horizontal, vertical and first and second diagonal lines, wherein the average does not include the first pixel.

24. The apparatus of claim 14, wherein 8 pixels neighbor the first pixel.

25. The apparatus of claim 13, wherein the input image data is a Bayer-pattern color digital image signal.
